(19) United States
(12) Patent Application Publication
(10) Pub. No.: US 2014/0041835 A1
(43) Pub. Date: Feb. 13, 2014

(54) COOLING DEVICE FOR A VEHICLE BATTERY

(71) Applicant: MAGNA STEYR Battery Systems GmbH & Co OG, Zettling (AT)

(72) Inventor: Bernhard WAHA, Judendorf-Strassengel (AT)

(73) Assignee: MAGNA STEYR Battery Systems GmbH & Co OG, Zettling (AT)

(21) Appl. No.: 13/958,649

(22) Filed: Aug. 5, 2013

(30) Foreign Application Priority Data
Aug. 8, 2012 (EP) 12179713.8

(51) Int. Cl. B60L 11/18

(52) U.S. Cl. CPC B60L 11/1874
USPC 165/104.19

(57) ABSTRACT

A cooling device for a vehicle battery with battery cells, and which includes a cooling body which thermally contacts the battery cells. The cooling body has channels through which a coolant flows. A coolant distributor is provided on the cooling body and includes an inflow and/or an outflow for coolant which is fluidically connected to certain channels. A first flow opening is formed at the inflow and/or outflow of the coolant distributor and extends in a direction of a main channel of the channels, the main channel being the channel which is furthest away from the inflow and/or outflow.

### CROSS-REFERENCE TO RELATED APPLICATIONS

The present application claims priority 35 U.S.C. §119 to European Patent Application No. 12 179 713.8 (filed on Aug. 8, 2012), which is hereby incorporated by reference in its entirety.

### TECHNICAL FIELD

Embodiments relate to a cooling device for a vehicle battery with battery cells, and includes a cooling body with channels through which a coolant flows and which is configured to thermally contact or otherwise communicate with the battery cells. A coolant distributor with an inflow and/or an outflow of coolant is provided on at least one end of the cooling body, and at least some of the channels of the cooling body are open into the coolant distributor and at least two channels are fluidically connected to the inflow and/or the outflow.

### BACKGROUND

High voltage batteries for electric and hybrid vehicles in particular are exposed to high loads from the charging and discharging (e.g., on recuperation) of large energy quantities in short time periods. Due to the internal resistance of the battery cells, such batteries heat up, which can lead to a reduction in battery life. Therefore, such battery systems are usually cooled, for example, by liquid cooling in which a cooling fluid flows through channels of a cooling body in order to cool the cooling body, which in turn is in thermal contact with the battery cells in order to dissipate the heat from the battery cells. In particular, to deflect the coolant and for the supply and discharge of coolant from the cooling device, often end caps are placed on one or both ends of the cooling body, for example, so-called coolant distributors which usually also have an inflow and an outflow for the coolant. It is also known for cooling bodies to have several channels or grooves arranged in parallel and/or in series in order to achieve a good heat transfer between the coolant and the cooling body.

A cooling device of the generic type is known from DE 10 2008 027 293 A1. The device for cooling a vehicle battery comprises a plurality of electrical storage elements and a cooling body formed as at least one extruded profile with channels through which a fluid can flow, in which the electrical storage elements are in thermal contact with the cooling body, and heat from the storage elements can be transmitted to the fluid. A header can be arranged at one end of the cooling body, in which at least some of the channels open into the header. The header allows the distribution of a fluid stream to the channels. The header can also have partition walls in its transverse direction for separating different chambers or part areas of the header in order to allow single or multiple deflection of the fluid stream in the cooling body. The cooling body can extend in stages to different depths in the header in order to take account of the pressure fall of the fluid over the length of the header and ensure an even fluid flow through the cooling body.

One disadvantage of such known cooling devices is that, due to the complex construction of the cooling body, even fluid flow can either not be achieved at all or only with high production costs.

### SUMMARY

In accordance with embodiments, a cooling device having an enhanced structural design is provided which allows an even fluid flow and which may be manufactured in a simple and economic manner.

In accordance with embodiments, a cooling device for a vehicle battery with battery cells includes at least one of: a cooling body with channels through which a coolant flows and which is configured to thermally contact the battery cells; a coolant distributor with an inflow and/or an outflow of coolant on at least one end of the cooling body, wherein at least some of the channels of the cooling body open into the coolant distributor, at least two channels are fluidically connected to the inflow and/or the outflow, a first flow opening is formed at the inflow and/or outflow of the coolant distributor and points in the direction of a main channel, and the main channel of the at least two channels fluidically connected to the inflow and/or outflow is the channel which is furthest away from the inflow and/or outflow.

In accordance with embodiments, a cooling device for a vehicle battery with battery cells includes at least one of: a cooling body with channels through which a coolant flows and which is configured to thermally contact the battery cells; and a coolant distributor with an inflow and/or an outflow of coolant provided on at least one end of the cooling body, the inflow and/or outflow having a first flow opening which extends in a direction of a main channel of the channels, wherein: (i.) some of the channels of the cooling body are open to the coolant distributor and a predetermined number of channels are fluidically connected to the inflow and/or the outflow, and (ii.) the main channel of the predetermined number of channels fluidically connected to the inflow and/or outflow is the channel which is furthest away from the inflow and/or outflow.

In accordance with embodiments, a cooling device for a vehicle battery with battery cells includes at least one of: a cooling body with channels through which a coolant flows and which is configured to thermally contact the battery cells, wherein one of the channels comprises a main channel; and a coolant distributor provided on at least one end of the cooling body, the coolant distributor having an inflow with a first flow opening which extends in a direction of the main channel, wherein: (i.) a predetermined number of channels are fluidically connected to the inflow, and (ii.) the main channel comprises the channel which is furthest away from the inflow.

Accordingly, at least an inflow or an outflow, or both the inflow and the outflow of the coolant into the cooling device, is/are provided on the cooling body. For example, at least two channels of the cooling body are fluidically connected with the inflow. Fluidic connection here means a direct fluidic connection of the respective channel in a direction of the inflow, or similarly the outflow, and not an indirect connection, for example, via a closed coolant circuit.

The inflow or outflow, or both, have a flow opening which is oriented in the direction of the fluidic connected channel which is furthest away, so that the coolant reaches the channel furthest away, which is served via the associated inflow or outflow, in as direct a line as possible. This counters the tendency of the coolant to flow for preference into the channel of the cooling body closest to the inflow, and thus, achieves an even coolant flow.

In accordance with embodiments, the first flow opening fluidically connects the inflow and/or outflow to a respective distribution chamber of the coolant distributor, in which the at least two channels fluidically connected to the inflow and/or outflow open into the respective distribution chamber. For example, the coolant flows through the first flow opening of the inflow into an inflow distribution chamber, and from this inflow distribution chamber into the channels of the cooling body which open into the inflow distribution chamber. Similarly, an outflow distribution chamber can be formed at the outflow, so that coolant from the channels opening into the outflow distribution chamber collects in the outflow distribution chamber and flows from the outflow distribution chamber to the outflow.

In accordance with embodiments, a second flow opening is formed at the inflow and/or outflow of the coolant distributor which is formed smaller than the first flow opening. The second flow opening is structurally configured to prevent the formation of an inclusion of air between the first flow opening and the closest channel.

In accordance with embodiments, the second flow opening extends at least approximately in the direction of the channel of the cooling body which opens into the coolant distributor closest to the first flow opening, in order to prevent optimally the formation of an air inclusion.

In accordance with embodiments, both the inflow and the outflow are formed on the coolant distributor and a cover element is arranged on the second end of the cooling body to deflect the coolant. Thus, a U-shaped flow through the cooling body can be achieved, and connections for the inflow and outflow of the cooling device can be connected to the same end of the cooling device. If the inflow and outflow are formed on the same end of the cooling body, the inflow may lies below the outflow in the installation position of the cooling body.

In accordance with embodiments, the cooling body is formed as an extruded profile, in particular, of a metal such as aluminium. The cooling body can have largely homogeneous channels with the same cross sections over its length.

In accordance with embodiments, the coolant distributor may be composed of a plastic material, in particular, by way of an injection moulding process. The coolant distributor may be attached, joined or connected to the cooling body, for example, by an adhesive.

In accordance with embodiments, the coolant distributor may be composed of a metal material such as aluminium, in particular, by way of a pressure die casting process. The coolant distributor may be attached, joined or connected to the cooling body, for example, by soldering or welding.

### DRAWINGS

In the text which follows, embodiments will be described, by way of example, referring to the drawings, in which:

FIG. 1 illustrates a diagrammatic depiction of a cooling device in accordance with embodiments of the invention.

FIG. 2 illustrates a diagrammatic detailed depiction of the coolant distributor of FIG. 1.

### DESCRIPTION

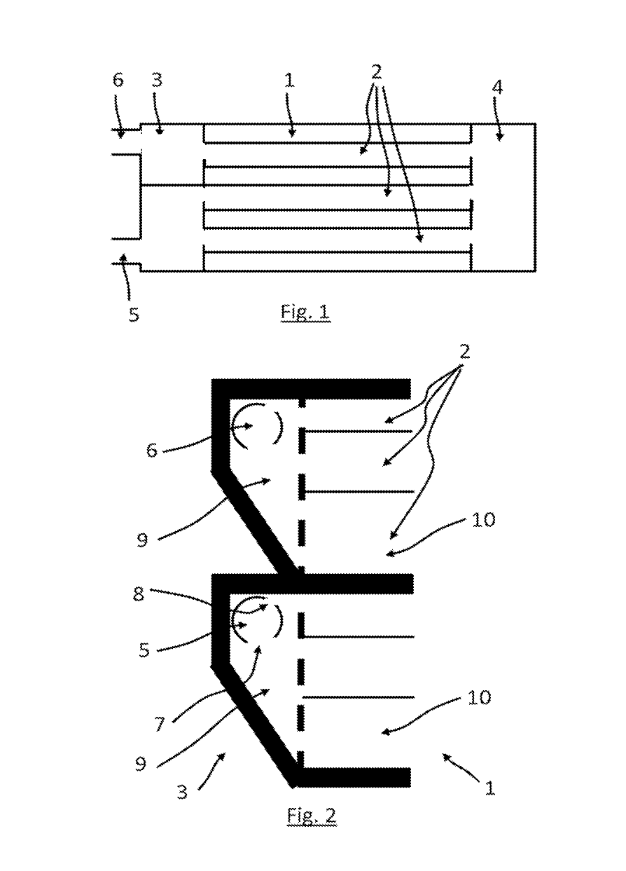

FIG. 1 illustrates diagrammatically a cooling device for a vehicle battery comprising a cooling body 1 with a plurality of channels 2 through which a coolant flows. In accordance with embodiments, the number of channels 2 may be an even number.

A coolant distributor 3 having an inflow 5 and an outflow 6 is arranged at a first end of the cooling body 1, i.e., at the same end of the cooling body 1. A cover element 4 is arranged at an opposite, second end of the cooling body 1. In contrast to the coolant distributor 3, the cover element 4 has no inflow or outflow and is structurally configured to deflect the coolant flow within the cooling body 1. The channels 2 of the cooling body 1 open into the coolant distributor 3 and the cover element 4. A partition wall is arranged on the coolant distributor 3 and separates a distribution chamber 9 in the region of the inflow 5 from a further distribution chamber 9 in the region of the outflow 6.

First flow openings 7 are formed on the inflow 5 and the outflow 6 and extend in a direction of a respective main channel 10. The main channel 10 of each respective channel 2 fluidically connected to the inflow 5 and/or outflow 6 is the channel 2 which is furthest away from the inflow 5 and/or outflow 6. A second flow opening 8 is formed at the inflow 5 and outflow 6 and is structurally configured to prevent the formation of an air inclusion.

Coolant flowing from the inflow 5 passes through the first flow opening 7 into the distribution chamber 9 in the region of the inflow 5, and is deflected in particular in the direction of the opening of the main channel 10 furthest away, but via the distribution chamber 9 also enters the other channels 2 which are fluidically connected to the distribution chamber 9. Through the channels 2 illustrated at the bottom in FIGS. 1 and 2, the coolant reaches the cover element 4 where it is deflected, so that via the above-mentioned channels 2 it reaches the other distribution chamber 9 in the region of the outflow 6. There the coolant leaves the distribution chamber 9, preferably through the first flow opening 7 which is formed on the outflow 6, and in a smaller quantity through the second flow opening 8 of the outflow 6.

By the use of at least one correspondingly oriented flow opening, embodiments of the invention therefore achieves an even coolant flow in a simple and economic manner.

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

### LIST OF REFERENCE SIGNS

1 Cooling body
2 Channel
3 Coolant distributor
4 Cover element
5 Inflow
6 Outflow
7 First flow opening
8 Second flow opening
9 Distribution chamber
10 Main channel

What is claimed is:

1. A cooling device for a vehicle battery with battery cells, the cooling device comprising:
a cooling body with channels through which a coolant flows and which is configured to thermally contact the battery cells; and
a coolant distributor with an inflow and/or an outflow of coolant provided on at least one end of the cooling body, the inflow and/or outflow having a first flow opening which extends in a direction of a main channel of the channels,
wherein:
some of the channels of the cooling body are open to the coolant distributor and a predetermined number of channels are fluidically connected to the inflow and/or the outflow,
the main channel of the predetermined number of channels fluidically connected to the inflow and/or outflow is the channel which is furthest away from the inflow and/or outflow.

2. The cooling device of claim 1, wherein the predetermined number of channels comprises at least two channels.

3. The cooling device of claim 2, wherein the first flow opening fluidically connects the inflow and/or outflow to a respective distribution chamber of the coolant distributor.

4. The cooling device of claim 3, wherein the at least two channels fluidically connected to the inflow and/or outflow open into the respective distribution chamber.

5. The cooling device of claim 1, further comprising a second flow opening formed at the inflow and/or outflow of the coolant distributor.

6. The cooling device of claim 5, wherein the second opening has an area which is smaller than the area of the first flow opening.

7. The cooling device of claim 7, wherein the second flow opening extends in a direction of the channel of the cooling body which opens into the coolant distributor closest to the first flow opening.

8. The cooling device of claim 1, wherein the inflow and the outflow are located at a first end of the cooling body.

9. The cooling device of claim 8, further comprising a cover element configured to deflect the coolant that flows through the cooling body.

10. The cooling device of claim 9, wherein the cover element is arranged at a second end of the cooling body.

11. The cooling device of claim 1, wherein the cooling body comprises a metal material.

12. The cooling device of claim 11, wherein the metal material comprises aluminium.

13. The cooling device of claim 1, wherein the coolant distributor comprises a plastic material.

14. The cooling device of claim 1, wherein the coolant distributor comprises a metal material.

15. The cooling device of claim 14, wherein the metal material comprises aluminium.

16. A cooling device for a vehicle battery with battery cells, the cooling device comprising:
a cooling body with channels through which a coolant flows and which is configured to thermally contact the battery cells, wherein one of the channels comprises a main channel; and
a coolant distributor provided on at least one end of the cooling body, the coolant distributor having an inflow with a first flow opening which extends in a direction of the main channel,
wherein:
a predetermined number of channels are fluidically connected to the inflow,
the main channel comprises the channel which is furthest away from the inflow.

17. The cooling device of claim 16, wherein the predetermined number of channels comprises at least two channels.

18. The cooling device of claim 17, wherein the first flow opening fluidically connects the inflow to a respective distribution chamber of the coolant distributor.

19. The cooling device of claim 16, further comprising a second flow opening formed at the inflow of the coolant distributor, the second opening having an area which is smaller than the area of the first flow opening.

20. The cooling device of claim 16, further comprising a cover element configured to deflect the coolant that flows through the cooling body, the cover element is arranged on the cooling body at an end opposite to the inflow.
